(19) United States
(12) Patent Application Publication
(10) Pub. No.: US 2013/0013283 A1
(43) Pub. Date: Jan. 10, 2013

(54) DISTRIBUTED MULTI-PASS MICROARCHITECTURE SIMULATION

(76) Inventor: Ari Gam, Petah-Tikva (IL)

(21) Appl. No.: 13/176,874

(22) Filed: Jul. 6, 2011

(51) Int. Cl. G06G 7/62

(52) U.S. Cl. 703/21

(57) ABSTRACT

A system including a microarchitecture model, a memory model, and a plurality of snapshots. The microarchitecture model is of a microarchitecture design capable of executing a sequence of program instructions. The memory model is generally accessible by the microarchitecture model for storing and retrieving the program instructions capable of being executed on the microarchitecture model and any associated data. The plurality of snapshots are generally available for initializing a number of instances of the microarchitecture model, at least some of which may contain values assigned to one or more registers or memory regions in response to interaction with one or more external entities during a first pass of a simulation of the microarchitecture. The number of instances is generally greater than one and generally perform high-detail simulation. The number of instances, when launched and executed during a second pass of the simulation of the microarchitecture, have run time periods that overlap.

### FIELD OF THE INVENTION

The present invention relates to electronic design automation tools generally and, more particularly, to a method and/or apparatus for implementing distributed multi-pass microarchitecture simulation.

### BACKGROUND OF THE INVENTION

A microarchitecture simulator allows architects to evaluate a design before implementing the design. The microarchitecture simulator allows logic design engineers to verify the implementation before tapeout (i.e., prior to artwork for a photomask of the microarchitecture being sent for manufacture). The microarchitecture simulator can be sold to clients to allow the clients to develop software for the microarchitecture and accurately test the software.

A disadvantage of simulation is that simulation runtime on the microarchitecture simulator is significantly slower than runtime on actual hardware. In order to mitigate the disadvantage, two types of simulation are available: high-detail simulation and instruction-set-only simulation. Instruction-set-only simulation is faster than high-detail (or cycle accurate) simulation. Clients can choose which simulation to use.

The market today does not offer faster computers for running simulations than were available last year. Instead, multicore computers and cloud computing have come into widespread use by both internal and external simulator clients. In order to leverage the move to multicore computers and cloud computing, and develop competitive simulators, simulation needs to be divided into tasks that can be executed in overlapping time periods. However, divided simulation can be error-prone, hard to debug, non-deterministic, or require synchronization objects that degrade performance. Furthermore, simulation is inherently sequential, as it is non-computable to predict the state of the simulation at a certain point in the future before completing the calculation steps that lead to that point.

It would be desirable to have a method and/or apparatus for implementing distributed multi-pass microarchitecture simulation.

### SUMMARY OF THE INVENTION

The present invention concerns a system including a microarchitecture model, a memory model, and a plurality of snapshots. The microarchitecture model is of a microarchitecture design capable of executing a sequence of program instructions. The memory model is generally accessible by the microarchitecture model for storing and retrieving the program instructions capable of being executed on the microarchitecture model and any associated data. The plurality of snapshots are generally available for initializing a number of instances of the microarchitecture model, at least some of which may contain values assigned to one or more registers or memory regions in response to interaction with one or more external entities during a first pass of a simulation of the microarchitecture. The number of instances is generally greater than one and generally perform high-detail simulation. The number of instances, when launched and executed during a second pass of the simulation of the microarchitecture, have run time periods that overlap.

The objects, features and advantages of the present invention include providing distributed multi-pass microarchitecture simulation that may (i) divide high-detail simulation into parallel autonomous tasks that are deterministic and contention-free, (ii) provide high-detail simulation run time that decreases linearly as the number of processors/cores available to run the simulation is increased, yet with negligible loss of precision, (iii) handle interactions with an external entity during simulation, (iv) provide simulation of input/output to the external entity without imposing special interoperability requirements, (v) utilize a multicore computer, (vi) utilize cloud computing resources, (vii) generate a chronological record of input/output values during a first pass for use during a second pass, (viii) launch multiple high-detail simulator instances in parallel, (ix) aggregate results from multiple high-detail instances to provide overall performance statistics, (x) have a space overhead that may be practically independent of the total number of instructions run in the high-detail mode, and/or (xi) provide overall statistics for virtually all instructions in a full run of a program being simulated (with negligible loss of precision).

### BRIEF DESCRIPTION OF THE DRAWINGS

These and other objects, features and advantages of the present invention will be apparent from the following detailed description and the appended claims and drawings in which:

FIG. 1 is a diagram illustrating a simulation flow in accordance with an example embodiment of the present invention;

FIG. 2 is a block diagram illustrating a process by which a simulator in accordance with the present invention may be used to generate performance statistics for a microarchitecture design;

FIGS. 3A and 3B are a flow diagram illustrating example interactions with an external entity; and

FIG. 4 is a block diagram illustrating a simulation in accordance with the present invention.

### DETAILED DESCRIPTION OF THE PREFERRED EMBODIMENTS

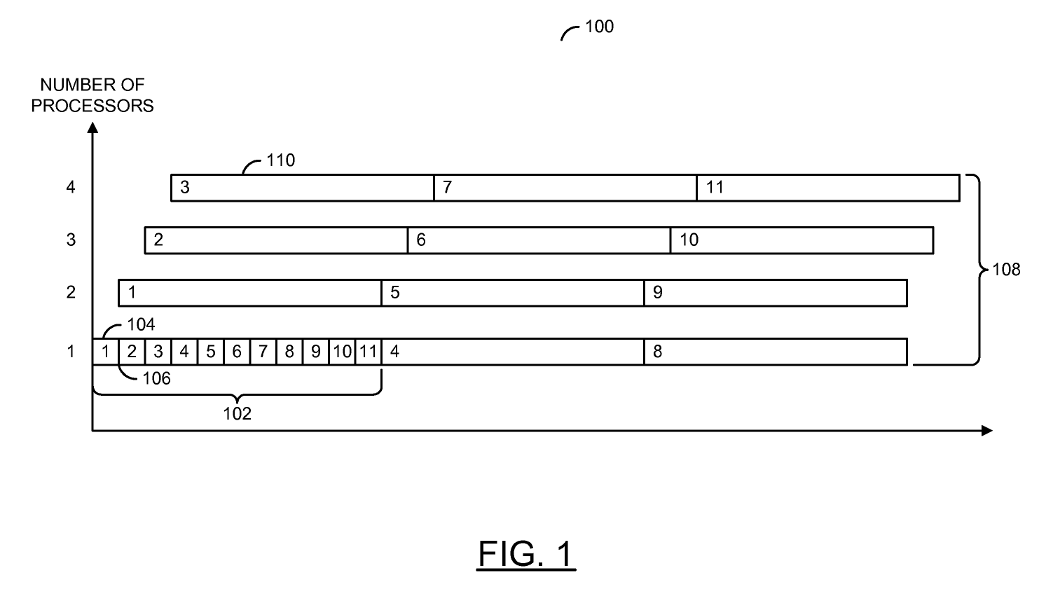

Referring to FIG. 1, a diagram of a process 100 is shown illustrating a simulation flow in accordance with an example embodiment of the present invention. In one example, a simulation in accordance with an example embodiment of the present invention is generally divided into a functional pass and a high detail pass. The high-detail simulation pass is generally divided into parallel autonomous tasks in a deterministic and contention-free manner, and with negligible loss of precision. A simulator in accordance with an example embodiment of the present invention may utilize a multicore computer or cloud computing resources efficiently and may be easier to debug and maintain than if other forms of parallelism were applied.

In a first step, the process 100 may perform a first (or functional) pass 102. In one example, the first pass 102 may implement an instruction-set-only simulation. For example, an executable program targeted for the microarchitecture corresponding to the process 100 may be run on an instruction-set simulator. During the first pass 102, a number of instructions 104 may be simulated. After simulating the number of instructions 104, a snapshot 106 of the simulation state may be recorded, and the first pass 102 may continue by simulating groups of instructions 104 and recording corresponding snapshots 106. Each snapshot 106 may include, but is not limited to, the entire state of the simulation at the particular point in time. For example, a snapshot 106 may comprise one or more modified register values and/or modified memory locations/regions. The number of instructions 104 simulated between snapshots 106 may be determined, in one example, to minimize overhead and/or loss of precision. For example, the number of instruction 104 between snapshots 106 is generally the smallest number such that both the overhead caused by taking the snapshots 106 and a loss of precision due to aggregation are negligible.

The process 100 generally allows simulation of the executable program to include interactions with an external entity during the first pass 102. For example, the executable program may utilize an external file system, console, etc. for input and output. The input/output may be done, in one example, by designated microarchitecture instructions and/or by assigning designated values to some registers or memory regions, and expecting the external entity to assign return values. In one example, the process 100 may simulate the input/output behavior of the program by monitoring designated values/instructions and/or notifying the external entity accordingly. The process 100 may further simulate the input/output behavior of the program by assigning values based upon a response from the external entity. During the first pass 102, any values assigned based upon a response from an external entity are generally recorded chronologically.

When at least one snapshot 106, and any associated I/O data, is available, the process 100 may begin a second (or high-detail) pass 108. The second pass 108 generally comprises launching a number of high-detail (e.g., cycle accurate, pipe accurate, register-transfer level (RTL), etc.) simulator instances 110. The high-detail simulator instances 110 may be executed such that the corresponding execution time periods generally overlap. The number of high-detail simulator instances 110 launched and running (e.g., in parallel, or simultaneously) may be determined, in one example, according to the number of free processors/computers available to run the simulation. In general, one instance 110 (e.g., instance 110-1) runs the program from the beginning, and each of the other instances 110 (e.g., instances 110-2, 110-3, . . . , 110-11) may run concurrently using a unique saved snapshot 106 as a starting point. Whenever a particular high-detail simulator instance 110 reaches a point that has already been handled (e.g., reaches a point represented by a subsequent snapshot 106), the particular high-detail simulator instance 110 is generally terminated. Whenever there is a free processor/computer and there is a ready snapshot 106 that is not yet used, a new high-detail simulator instance 110 may be launched with that snapshot 106 as the starting point. In general, the first pass 102 and second pass 108 may be occurring concurrently.

The high-detail simulation performed during the second pass 108 generally yields valuable results (e.g., cycle count, average cycles per instruction, cache hit rate, etc.) compared to instruction-set-only (or functional) simulation. During the second pass 108, the results from the simulation instances 110 may be aggregated (e.g., to provide overall performance statistics). There is generally no need to perform output during the high-detail pass, since all output has already been done by the functional pass. Therefore, no connection with external entities is established during the second pass 108. In order to simulate input during the second pass 108, whenever a simulator instance 110 reaches a point where a response from an external entity should have been received, the values stored during the first pass 102 may be restored and assigned to the appropriate locations.

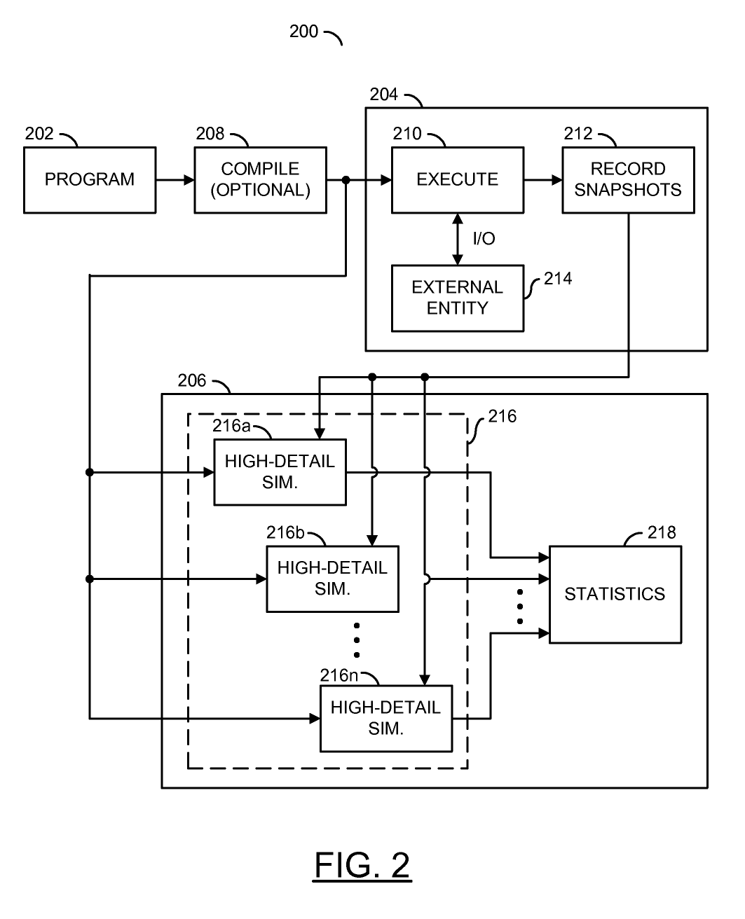

Referring to FIG. 2, a block diagram is shown illustrating a process 200 by which microarchitecture simulation in accordance with an embodiment of the present invention may use an executable program to generate performance statistics for a microarchitecture design. In one example, the process 200 may comprise a step (or state) 202, a step (or state) 204, a step (or state) 206, and a step (or state) 208. The step 208 may be omitted (optional).

In the step 202, an executable program may be generated. The executable program may be configured for determining performance statistics for the microarchitecture design. In the step 204, a first pass of the microarchitecture simulation in accordance with the present invention may be performed. The step 204 may include a step (or state) 210, a step (or state) 212, and a step (or state) 214. During the first pass, the program may be executed (e.g., on a electronic design automation (EDA) tool) in the step 210. In one example, the tool used to execute the program may be implemented as a fast, instruction-accurate processor model. Also during the first pass, snapshots of the simulation state may be taken (e.g., in the step 212) and interaction with an external entity may be simulated (e.g., in the step 214). When at least one snapshot has been recorded, the process 200 may concurrently performing the step 206. In the step 206, a second pass of the microarchitecture simulation may be started. The step 206 may comprise a step (or state) 216, and a step (or state) 218. In the step 216, a high-detail simulation of the executable program generated in the step 202 may be performed. In the step 218, performance statistics may be generated based upon the high-detail simulation of the step 216.

The executable program generated in the step 202 may be compiled or uncompiled. In one example, the execution step 210 may be implemented with an interpreter that takes an uncompiled program directly. In another example, the process 200 may implement the step 208. In the step 208, the program may be compiled to produce a machine language version of the program that may be executed during the simulation in accordance with the present invention. In one example, the steps 204 and 206 may be configured to take a similar type (e.g., compiled, uncompiled, etc.) of executable program. In another example, the steps 204 and 206 may be configured to take dissimilar types of executable programs. For example, one step may take a compiled program and the other may take an uncompiled program.

The steps 210, 212 and 214 may be repeated such that a number of snapshots are recorded during the execution of the program by the tool. Interaction with the external entity may take place a number of times during the execution of the program by the tool. In the step 214, input and output operations with the external entity may be simulated by designated microarchitecture instructions and/or by assigning designated values to some registers or memory regions, and expecting the external entity to assign return values. The input/output behavior of the program may be simulated by monitoring the designated values/instructions and/or notifying the external entity accordingly. The input/output behavior of the program may be simulated further by assigning values based upon a response from the external entity. During the first pass performed in the step 204, any values assigned based upon a response from the external entity are generally recorded chronologically.

In one example, the external entity may be an interactive terminal (or console) and the execution of the program generated in the step 202 may involve retrieving input from a keyboard of the terminal and displaying output on a screen (or display) of the terminal. In another example, the external entity may be implemented by a file system, and the execution of the program generated in the step 202 may involve requesting the file system to retrieve the contents of a file, receiving the contents of the file from the file system, and then requesting the file system to delete the file. In one example, interoperability with the external entity may only take place in step 214. For example, the external entity may not support interaction during any other step in the overall process 200. For example, the console may delete the keystrokes from internal buffers of the console after providing the keystrokes in step 214. In another example, the file system may permanently delete a file if requested to during step 214, such that requesting to retrieve the file after deletion may fail.

The step 216 performed during the second pass may comprise multiple steps 216a-216n. The multiple steps 216a-216n may involve performing multiple instances of a high-detail simulator. The multiple instances of the high-detail simulator performed in the steps 216a-216n may receive the executable program generated in the step 202, respective ones of the snapshots recorded in the step 212, and any input data associated with the snapshots. The multiple instances of the high-detail simulator performed in the steps 216a-216n may be launched and executed concurrently (e.g., with run time periods that overlap at least partially). Results from the multiple instances of the high-detail simulator performed in the steps 216a-216n may be aggregated in the step 218 to generate overall performance statistics for the microarchitecture being simulated. The performance statistics may include, but are not limited to, the total number of cycles required to execute the executable program generated in the step 202, the average number of cycles to execute an instruction of the executable program, the number of times a cache is accessed, etc. The performance statistics may be generated for substantially all instructions in a full run of, for example, a benchmark program with minimal loss of precision

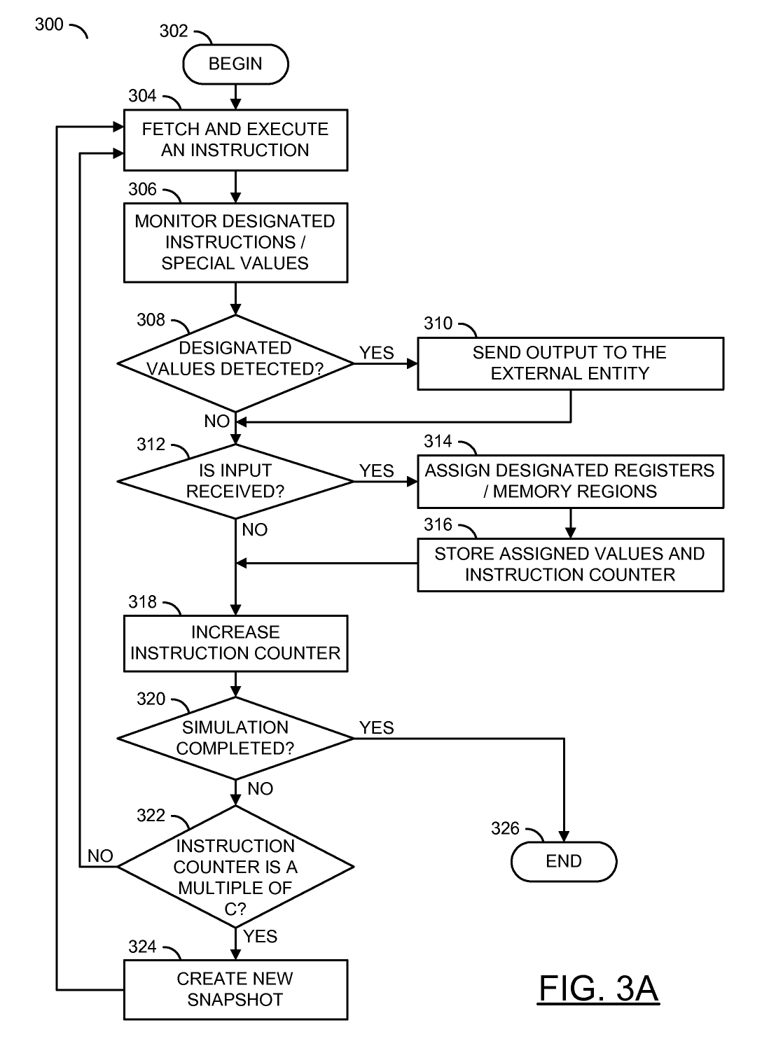

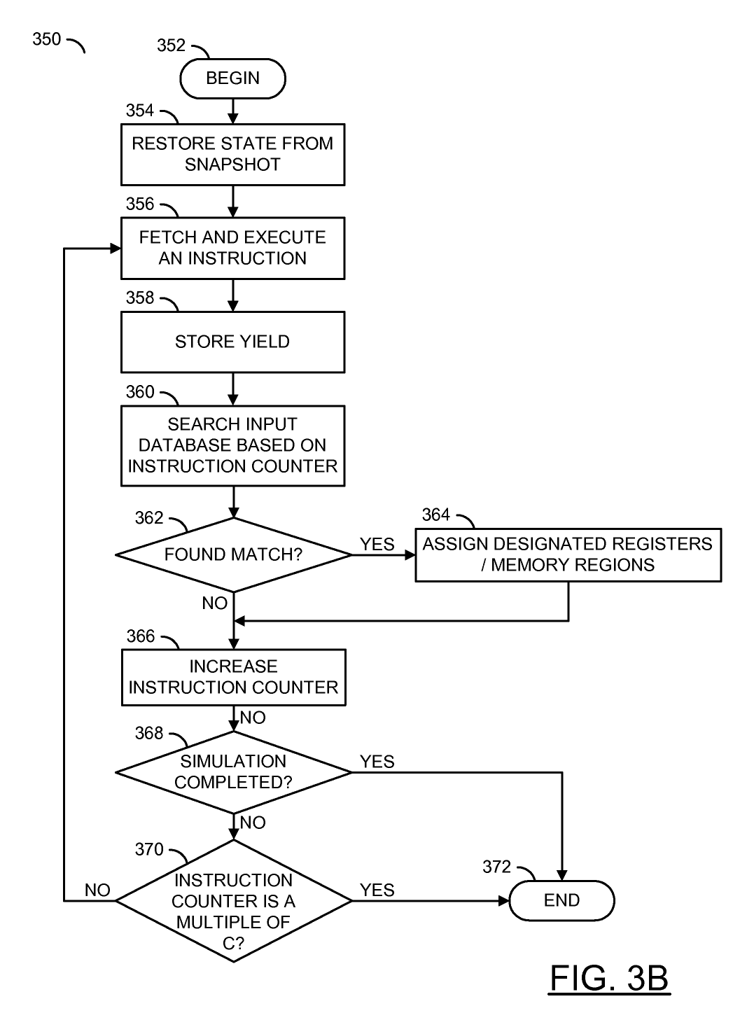

Referring to FIGS. 3A and 3B, diagrams are shown illustrating a process 300 and a process 350, respectively, in accordance with an example embodiment of the present invention. The process 300 generally illustrates an example of a first pass where the executable program may be run on an instruction-set simulator. The process 300 may comprise a step (or state) 302, a step (or state) 304, a step (or state) 306, a step (or state) 308, a step (or state) 310, a step (or state) 312, a step (or state) 314, a step (or state) 316, a step (or state) 318, a step (or state) 320, a step (or state) 322, a step (or state) 324, and a step (or state) 326. In the step 302, the process 300 may begin the first (or functional) simulation pass. In the step 304, one or a minimal number of instructions may be fetched from the memory model and executed. Execution in the step 304 may comprise reading and/or writing one or more registers and/or memory regions. In the step 306, the process 300 may examine the registers and/or memory regions that may have been modified in the step 304. In addition, the process 300 may check whether a designated microarchitecture instruction was executed in the step 304.

In the step 308, the process 300 may determine whether designated values were detected. When designated values are detected that indicate that output should be sent to an external entity, the process 300 may move to the step 310 to send output to the external entity according to the detected values. Otherwise, the process 300 moves to the step 312. Independently, in step 312 the process 300 may determine whether input has been received from the external entity. If input has been received, the process 300 may move to the step 314. Otherwise, the process 300 moves to the step 318. In the step 314, the process 300 may assign values to certain registers and/or memory regions according to the input. In addition, the process 300 may move to the step 316 where the values may also be stored in a data structure indexed by the current value of the instruction counter. The process 300 may then proceed to the step 318.

In the step 318, the process 300 may increase the instruction counter according to the number of instructions executed in step 304 and move to the step 320. In the step 320, the process 300 may determine whether the executable program has been completely run. If not, the process 300 may move to the step 322. Otherwise, the process 300 moves to the step 326 and terminates. In the step 322, the process 300 examines whether a predefined number (e.g., C) of instructions have been simulated since the beginning of the process 300 or the last snapshot. In one example, the value C is a value determined such that both the overhead caused by taking snapshots and the loss of precision caused by aggregation are negligible. If C instructions have not been simulated since the beginning of the process 300 or the last snapshot, the process 300 may return to the step 304. When C instructions have been simulated since the beginning of the process 300 or the last snapshot, the process 300 may move to the step 324. In the step 324, a snapshot of the current simulation state may be taken. The snapshot of the current simulation state may comprise, in one example, register and/or memory values changed since the last snapshot was taken. After the snapshot of the current simulation state has been recorded, the process 300 moves back to the step 304.

Referring to FIG. 3B, a diagram of a process 350 is shown illustrating an example of the executable program being run on high-detail simulator instance. One instance may start from the beginning of the program and other instances may run once a snapshot that has not yet been handled is available. The process 350 may comprise a step (or state) 352, a step (or state) 354, a step (or state) 356, a step (or state) 358, a step (or state) 360, a step (or state) 362, a step (or state) 364, a step (or state) 366, a step (or state) 368, a step (or state) 370, and a step (or state) 372. Each high-detail simulator instance, when launched, may begin in the step 352.

In the step 354, the process 350 may restore the entire state of the simulation from a respective snapshot (or the state may be reset when starting from the beginning of the program). In the step 356, one or a minimal number of instructions may be fetched from the memory model and executed. In the step 358, results of the execution of the instruction(s) (e.g., cycle count, average cycles per instruction, cache hit rate, etc.) may be updated and stored. In the steps 360 and 362, a check may be made whether data indexed by the current value of the executed instruction counter exist in a database of input values. If so, the process 350 may move to the step 364. Otherwise, the process 350 may move to the step 366. In the step 364 the input values may be retrieved and stored in the appropriate registers and/or memory regions. In the step 366, the process 350 may increment the instruction counter according to the number of instructions executed in step 356 an move to the step 368.

In the step 368, the process 350 may determine whether the executable program has been completely run. If so, the process 350 may move to the step 372 and terminate. Otherwise, the process 350 may move to the step 370. In the step 370, the process 350 may determine whether C instructions have been simulated since the respective snapshot used to start the process 350 (or since the beginning of the program). If C instructions have not been simulated, the process 350 returns to the step 356. When C instructions have been simulated, the process 350 moves to the step 372 and terminates.

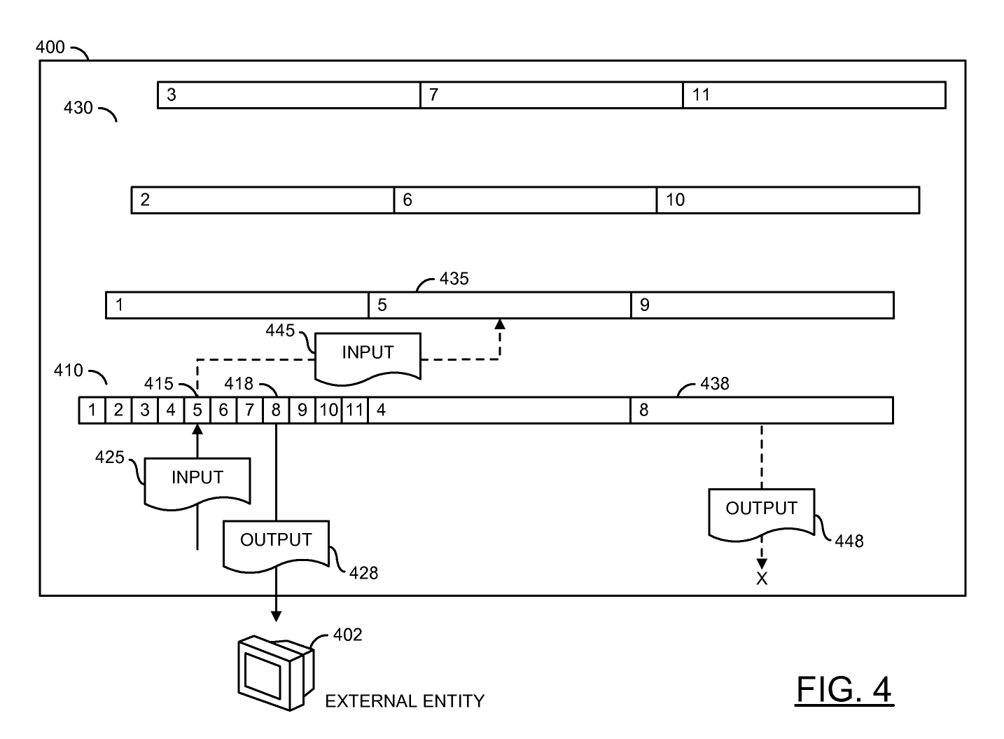

Referring to FIG. 4, a diagram of a process 400 is shown illustrating another example simulation flow in accordance with an example embodiment of the present invention. In one example, a simulation may perform interactions with an external entity 402. In one example, the external entity 402 may be an interactive terminal (console), including a keyboard and a display (or screen). The process 400 generally includes a functional pass 410 during which groups of instruction (e.g., 415, 418, etc.) are executed between snapshots (as described above in connection with FIG. 3A). In one example, the process 400 may retrieve input 425 from the keyboard of the external entity 402 while executing the instruction of the group 415. The process 400 may then display output 428 on the screen of the external entity 402 while executing the instruction of the group 418. While the functional pass 41Q is being run, the process 400 may also be running a high-detail pass 430. The high-detail pass 430 may comprise a number of instances (e.g., 435, 438, etc.). In one example, during execution of the instance 435, the instance 435 may retrieve the input 425 from a data structure 445, where the data structure 445 is indexed by the value of the executed instruction counter at the time the input is received in the first pass.

In one example, the executable program may be run on an instruction-set simulator. At the point 415 the instruction-set simulator may detect that input 425 has just been received from the external entity 402. As result, the instruction-set simulator may assign appropriate values to some registers and/or memory regions. In addition, the values of the registers and/or memory regions assign the values may be recorded chronologically (e.g., in the data structure 445, where the data structure 445 is indexed by the value of the executed instruction counter at the time the input is received).

At the point 418 the instruction-set simulator may detect that the program has set designated values to some registers and/or memory locations, and/or that a designated microarchitecture instruction is being executed. The designated values or instruction being executed may indicate that the executable program expects output 428 to be sent to the external entity 402. The instruction-set simulator may then send output 428 to the external entity 402. The executable program may also be run on a high-detail simulator. At the point 435, the value of the instruction counter of the executable program being executed may have the same value as at the point 415 in the first pass 410. In order for the run on the high-detail simulator to be functionally equivalent to the run on the instruction-set simulator, the values assigned to registers and/or memory regions at the point 415 may also be assigned at the point 435.

However, input may not be available for receipt from the external entity 402 at point 435 (e.g., the external entity 402 may have deleted keystrokes of the input 425 from the internal buffers after providing them at point 415). Instead, the instruction counter of the executable program being executed may be matched to the values stored in the data structure 445. Once a match is detected, the values stored at point 415 may be retrieved from the data structure 445 and assigned to the appropriate registers and/or memory regions at the point 435. At the point 438, the high-detail simulator may detect that the program has set designated values to some registers and/or memory locations, and/or that a designated microarchitecture instruction is being executed. The designated values and/or designated microarchitecture instruction being executed may indicate that the executable program expects output 448 to be sent to the external entity. However, the external entity might not be able to handle the output at the point 438 (e.g., because the external entity 402 has already displayed the output 428 at point 418). Therefore, although the program being executed at the point 438 may indicate the availability of output to the external entity 402, no connection with the external entity 402 is actually created at the point 438.

The functions performed by the diagrams of FIGS. 3A and 3B may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files or part of files on the storage medium and/or wired and/or wireless communication signals and/or one or more output signals representative of a physical object or substance, such as an audio and/or visual depiction. Execution of instructions contained in the computer product by the machine, along with operations of surrounding circuitry, may also transform one or more files or part of files on the storage medium and/or wired and/or wireless communication signals and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A system comprising:
a microarchitecture model of a microarchitecture design capable of executing a sequence of program instructions;
a memory model accessible by said microarchitecture model for storing and retrieving the program instructions capable of being executed on the microarchitecture model and any associated data; and
a plurality of snapshots available for initializing a number of instances of said microarchitecture model, at least some of which contain values assigned to one or more registers or memory regions in response to interaction with one or more external entities during a first pass of a simulation of said microarchitecture design, wherein said number of instances is greater than one, said number of instances perform high-detail simulation, and said number of instances, when launched and executed during a second pass of said simulation of said microarchitecture design, have run time periods that overlap.

2. The system according to claim 1, wherein said system is configured to accurately predict performance of said microarchitecture design when running said sequence of program instructions.

3. The system according to claim 1, wherein the microarchitecture model comprises software objects configured to perform processing unit functions.

4. The system according to claim 3, wherein the software objects include one or more of a prefetch and dispatch unit, an integer execution unit, a load/store unit, and an external cache unit accessible by said memory model.

5. The system according to claim 1, wherein the values assigned to one or more registers or memory regions in response to interaction with said one or more external entities during said simulation of said microarchitecture design are recorded chronologically during said first pass of said simulation.

6. The system according to claim 5, wherein said first pass of said simulation comprises instruction-set simulation.

7. The system according to claim 1, further comprising an execution tool configured to execute said sequence of program instructions in a single pass to generate said snapshots and associated input data.

8. The system according to claim 7, wherein a number of instructions simulated between the snapshots is configured to minimize overhead caused by taking the snapshots and loss of precision due to aggregation.

9. The system according to claim 1, wherein:
the number of instances running concurrently is based upon how many processors are available to run the simulation; and
one instance runs the program from the beginning and each of the remaining instances runs from a respective one of the plurality of snapshots as a starting point.

10. The system according to claim 9, wherein said number of instances are run using at least one of cloud computing resources, multicore computing resources and a plurality of computers.

11. The system according to claim 1, wherein said microarchitecture design is provided as a hardware design language representation of the microarchitecture.

12. A method for providing performance statistics for a microarchitecture design with the aid of a microarchitecture model, the method comprising the steps of:
providing a plurality of snapshots for a program which was previously executed using an instruction-set simulator, at least some of which contain values assigned to one or more registers or memory regions in response to interaction with one or more external entities during a simulation of said microarchitecture design;
providing the program in a model of a main memory accessible to the microarchitecture model; and
concurrently processing, in a number of instances of the microarchitecture model, instructions from the program, wherein the number of instances is greater than one and said instances perform high-detail simulation of said microarchitecture design.

13. The method according to claim 12, wherein the program is a benchmark program provided to measure microarchitecture performance.

14. The method according to claim 12, further comprising a step of determining and outputting performance statistics for the microarchitecture design.

15. The method according to claim 14, wherein the performance statistics include at least one statistic selected from the group consisting of a number of cycles used to execute said program, an average number of cycles per instruction for said program, and a cache hit rate.

16. The method according to claim 12, further comprising aggregating results from the number of instances to generate overall performance statistics for the microarchitecture design.

17. The method according to claim 16, wherein said performance statistics are generated for said microarchitecture design for substantially all instructions in a full run of a benchmark program with minimal loss of precision.

18. The method according to claim 12, wherein input, output, or both input and output are exchanged with one or more external entities without imposing interoperability constraints on the external entities.

19. The method according to claim 18, wherein said interoperability constraints include one or more of (i) a requirement to be able to replay an input from one or more of the external entities more than once, (ii) a requirement to be able to maintain correct functionality and integrity regardless of repeated output to one or more of the external entities, and (iii) a requirement to support one or both of concurrent exchange order and non-deterministic exchange order.

20. The method according to claim 12, further comprising providing a high-detail simulation having:
run time that decreases linearly as the number of processors available to run the simulation is increased; and
a space overhead that is substantially independent of the total number of instructions run in high-detail mode.
